(19) United States
(12) Patent Application Publication
(10) Pub. No.: US 2014/0290705 A1
(43) Pub. Date: Oct. 2, 2014

(54) Container Washing System

(71) Applicant: Lester Acosta Quimpo, Bronx, NY (US)

(72) Inventor: Lester Acosta Quimpo, Bronx, NY (US)

(21) Appl. No.: 14/242,179

(22) Filed: Apr. 1, 2014

Related U.S. Application Data
(60) Provisional application No. 61/807,398, filed on Apr. 2, 2013.

(51) Int. Cl. B08B 9/093; B08B 9/34

(52) U.S. Cl. CPC B08B 9/093; B08B 9/34
USPC 134/99.2; 134/170

(57) ABSTRACT

A washing system provides multiple layers of jet nozzles strategically oriented in an enclosed system for washing container accessories and containers. A fluid source, such as a sink provides a hot, high pressure fluid. A timer regulates the duration of the washing. At least two accessory nozzles discharge the fluid in a whirlpool form to clean the container accessories. An outer nozzle up to 120 degrees to clean a container outer surface. An inner nozzle extends through a container aperture to clean a container inner surface. The nozzles are configured to orient and position around the container and the container accessory to optimize the washing process in the outer surface, and the often difficult to access inner surface. The container is held in place while being washed through an adjustable upper holder and a threadably engaged lower holder while being washed under heavy pressure.

### CROSS-REFERENCE TO RELATED APPLICATIONS

The present Utility patent application claims priority benefit of the [U.S. provisional application for patent Ser. No. 61/807,398, entitled “Automatic Multiple Baby Bottle Washer”, filed on 2 Apr. 2013, under 35 U.S.C. 119(e). The contents of this related provisional application are incorporated herein by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to a container washing system. More particularly, the invention relates to a washing system for washing an external and internal surface of a container with a plurality of strategically oriented jet nozzles.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a bottle is a rigid container with a neck that is narrower than the body and a mouth.

However, other types of bottles, such as a jar or jug have a relatively large mouth or opening which may be as wide as the overall container. Typically, bottles are fabricated from various materials, including, without limitation, glass, clay, plastic, aluminum or other impervious materials.

Typically, bottles are typically used to store liquids such as water, milk, soft drinks, beer, wine, cooking oil, medicine, shampoo, ink, and chemicals. These contents may leave a dry residue after a duration. The debris can quickly accumulate bacteria and have other undesirable effects. The inner surface of the bottle may be difficult to access for removing the debris.

It is known that a dishwasher is a mechanical device for cleaning dishes and eating-utensils. Unlike manual dishwashing, which relies largely on physical scrubbing to remove soiling, the mechanical dishwasher cleans by spraying hot water, typically between 130 and 170° Fahrenheit at the dishes, with lower temperatures used for delicate items. A mix of water and detergent is circulated by a pump. Water is pumped to one or more rotating spray arms, which blast the dishes with the cleaning mixture. Dishwashers can be used to clean bottles, but accessing the inner surface and retaining the bottle nipples can be difficult.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A and 1B illustrates sectioned side views of an exemplary container washing system, where FIG. 1A illustrates an exemplary stationary accessory nozzle, and FIG. 1B illustrates an exemplary rotating accessory nozzle, in accordance with an embodiment of the present invention;

FIG. 2 illustrates a top view of an exemplary container washing system, in accordance with an embodiment of the present invention; and

FIG. 3 illustrates a sectioned side view of an exemplary inner nozzle washing an exemplary container inner surface, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

There are various types of washing systems for containers that may be provided by preferred embodiments of the present invention. In one embodiment of the present invention, the washing system may provide a simple, portable system for thoroughly washing most inner and outer facets of a container, such as a bottle without the use of electricity or numerous moving components. The system may provide multiple layers of jet nozzles in an enclosed system for washing a container accessory, a container inner surface, and a container outer surface. The container may be held in place through various fasteners while being washed under heavy pressure. The container may be defined by the inner surface, which engages the contents of the container, and the outer surface, which forms a surface for manipulating the container. The jet nozzles may be configured to orient and position around the container and the container accessory to optimize the washing process in the outer surface, and the often difficult to access inner surface.

In some embodiments, the container washing system is especially effective for washing a certain type of container. Though any container may be washed. However, in some embodiments, the container may include a narrow container aperture on which the contents of the container are dispensed, and a relatively broad container bottom end on which the container stands. Those skilled in the art will recognize that the container aperture may form a narrow neck on the container, thus making the inner surface difficult to access for washing. The system may utilize established sources of fluid to perform the washing. The system may also provide an established destination to drainage fluid, such as a kitchen sink. The system may include a plurality of connectors, supports, and nozzles that orient around the container to optimize the washing function. In some embodiments, system does not include movable parts, in the sense of joints. Though, a rotatable arm may be involved in one embodiment. Additionally, the system does not require the use of electrical power.

In some embodiments, the container washing system may include a fluid source for supplying the fluid for washing the container and a destination for a drainage fluid to spill out. The fluid source may discharge a fluid, such as hot water at a high pressure through an inlet conduit for distribution to an upper end and a lower end of the system. Prior to engaging the container and the container accessory, the fluid may pass through a timer portion that is operable to shut-off a flow of the fluid through the inlet conduit after a predetermined running cycle terminates. A cleaning composition dispenser may position in proximity to the fluid source and dispense a predetermined quantity of cleaning composition into the fluid for enhancing the washing.

In some embodiments, the inlet conduit may carry a portion of the fluid to the upper end. The upper end may include a cover for inhibiting spillage of the fluid. The inlet conduit may carry the fluid to at least two accessory nozzles configured to wash a container accessory setting on a container accessory frame. The at least two accessory nozzles may join with an accessory nozzle arm that rotates above the container accessory frame. The at least two accessory nozzles may also be stationary and offset from each other to form at least two opposing fluid currents. The opposing currents may create a whirlpool effect that is efficacious for optimizing washing of the container accessory. Any excess fluid from the at least two opposing fluid currents may pass through at least one container accessory aperture as a drainage fluid.

In some embodiments, the inlet conduit may carry a portion of the fluid that was not used in the at least two accessory nozzles to the lower end of the system. A container frame on the lower end provides a platform for supporting the container. The container frame may be arranged beneath the container accessory frame, and thereby receive the excess fluid from the opposing fluid currents washing the container accessory. A portion of the fluid from the inlet conduit may be carried into the at least one outer nozzle for washing a container outer surface. The at least one outer nozzle may spray at an angle of up to 120° for optimizing engagement with the container outer surface.

In some embodiments, the inlet conduit may carry a portion of the fluid, which was not used in the at least two accessory nozzles and the at least one outer nozzle, to at least one inner nozzle. The inner nozzle is configured to discharge a portion of the fluid through the container aperture for at least partial engagement with a container inner surface. The inner nozzle is disposed to at least partially enter the container from a generally linear configuration. In some embodiments, the accessory nozzles, the outer nozzle, and the inner nozzle may include a jet nozzle configuration that imparts high pressure fluid. The container holder helps maintain the positioning of the container while washing under this high pressure.

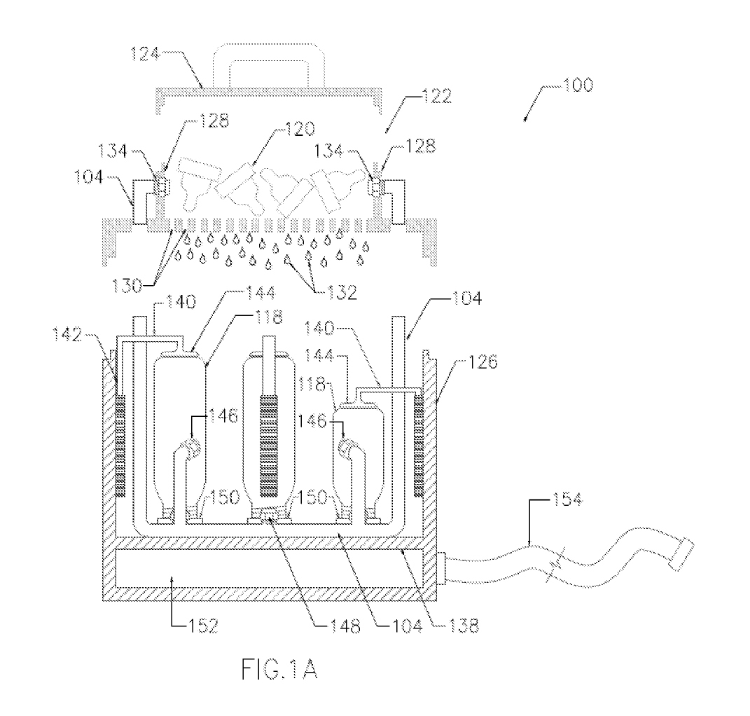

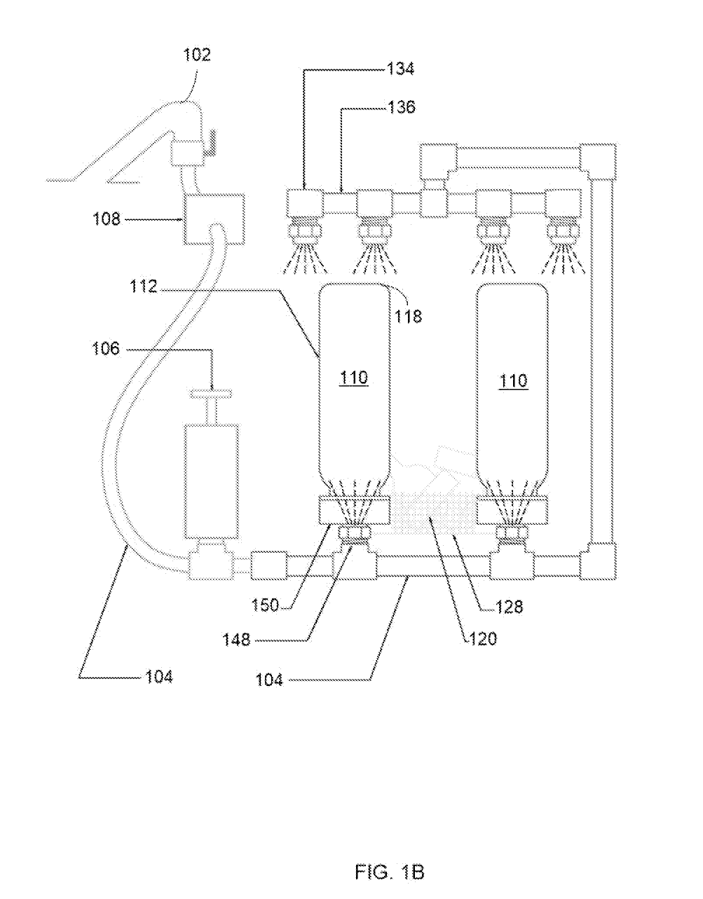

FIGS. 1A and 1B illustrates sectioned side views of an exemplary container washing system having an exemplary stationary accessory nozzle and an exemplary rotating accessory nozzle, in accordance with an embodiment of the present invention. In the present invention, a container washing system 100 may provide a simple, portable system for thoroughly washing most inner and outer facets of a container, such as a bottle without the use of electricity or numerous moving components. The washing system may provide a fluid source 102 that discharges a fluid through multiple layers of jet nozzles for washing a container accessory 120 and a container 110. The washing system may include a drain pan 152 beneath the container frame to collect the drainage fluid and a flexible drain hose 154 to spill onto the kitchen sink.

In some embodiments, the container may include, without limitation, a bottle configured to contain a liquid, a baby bottle, a vessel, a jug, and a cup. The container accessory may include, without limitation, a nipple for a baby bottle, a nipple cover, a cap, and a pacifier. The novelty of the present invention is the capacity to access a container inner surface 114 and a container outer surface 112 for optimal washing of the container. The container is defined by the container inner surface, which ideally engages the contents of the container, while the container outer surface forms a surface for manipulating the container. The container may further include a drinking glass, Sippy cup, coffee/beer mug, plate, saucer, bowl, utensil, food storage container and its cover.

In some embodiments, at least two accessory nozzles 134 discharge the fluid in at least two opposing currents to wash the container accessory. The accessory nozzles 134 may be stationary or rotatable on an accessory nozzle arm 136. At least one outer nozzle 146 may spray at an angle of up to 120° for washing the container outer surface. At least one inner nozzle 148 partially extends through a container aperture 116 to wash the container inner surface. The container aperture also acts as a drainage aperture for drainage fluid flowing out of the container. The system also provides stability to the container through a container holder 140, used to retain the container in a desired orientation while washing. In one embodiment, each of the nozzles may be configured as high pressure jet nozzles that can be oriented and positioned around the container and the container accessory for optimal washing conditions. In one embodiment, the nozzle may be sized at 2.5 for a flow rate of 0.25 gallons per minute and a 120° full cone spray angle. However in other embodiments, different flow rates and angles may be utilized.

In some embodiments, the container washing system may include a fluid source for supplying the fluid for washing the container. The fluid source may include, without limitation, a kitchen faucet, an external water source, and an external air source. The fluid source may discharge a fluid, such as hot water at a high pressure through an inlet conduit 104. The inlet conduit may include a rigid or flexible pipe configured to carry the fluid throughout the system. The inlet conduit may extend from the fluid source for distribution to an upper end 122 and a lower end 126 of the system. Prior to engaging the container and the container accessory, the fluid may pass through a timer portion 108 that is operable to shut-off a flow of the fluid through the inlet conduit after a predetermined running cycle terminates. A cleaning composition dispenser 106 may position in proximity to the fluid source and dispense a predetermined quantity of cleaning composition into the fluid for enhancing the washing. The cleaning composition may include, without limitation, soap, acid, and emulsifier. In some embodiments, the washing system may include a drain pan beneath the container frame to collect the drainage fluid and a flexible drain hose to spill onto a drain conduit, such as, but not limited to, a kitchen sink.

In some embodiments, the inlet conduit may carry a portion of the fluid to the upper end. The upper end may include a cover 124 for inhibiting spillage of the fluid Cover 124 may also help to prevent container accessories 120 from being dislodged while spinning The cover may be completely detachable, or may operate through a hinge. Additionally, the inlet conduit may carry the fluid to the at least two accessory nozzles. The accessory nozzles may be configured to wash the container accessory setting on a container accessory frame 128. The container accessories may be contained by the cylindrical wall of the container accessory frame 128 and cover 124. In typical operation, the pressurized hot water jet coming from the two opposing accessory nozzles 134 may spin container accessories 120 inside container accessory frame 128.

The at least two accessory nozzles may join with an accessory nozzle arm that rotates above the container accessory frame. However in other embodiments, the at least two accessory nozzles may be stationary. The at least two accessory nozzles may be offset from each other to form at least two opposing fluid currents. The opposing currents may create a whirlpool effect efficacious for optimizing washing of the container accessory. Any excess fluid from the at least two opposing fluid currents may pass through at least one accessory frame aperture 130 in the form of a drainage fluid 132. The drainage fluid may be recycled for further washing of the containers.

In some embodiments, the inlet conduit may carry a portion of the fluid that was not used in the at least two accessory nozzles to the lower end of the system. A container frame 138 on the lower end provides a platform for supporting the container. The container frame may be arranged beneath the container accessory frame, and thereby receive the drainage fluid from the opposing fluid currents washing the container accessory. A portion of the fluid from the inlet conduit may be carried into the at least one outer nozzle for washing a container outer surface. The at least one outer nozzle may spray at an angle of up to 120° for optimizing engagement with the container outer surface. In one embodiment, the nozzle may be sized at 2.5 for a flow rate of 0.25 gallons per minute and a 120° full cone spray angle. However in other embodiments, different flow rates and angles may be utilized.

In some embodiments, the container frame is disposed to position on a lower end of the system. The container frame may include an upper container holder configured to retain a container bottom end 118 in a predetermined position for washing. In one example, the container may include a bottle with the container bottom end oriented above the container aperture. In this manner, gravity forces the fluid in the container inner surface to flow out and drain from the container aperture. The upper container holder is disposed to adjustably extend and retract along a longitudinal axis of the container to allow for use with different container sizes and shapes. The upper container holder includes a rod 142 configured to extend and retract. The extension and retraction may utilize a sleeve that receives the rod. The rod includes a first end disposed to join with the container frame. The rod further includes a second end comprising a retaining plane 144 configured to engage the container bottom end.

The container frame further comprises a lower container holder 150 for holding the opposite end of the container steady while washing. The lower container holder may include a block having inner threads and sized to form a snug fit around the container aperture area, such as a bottle neck. The lower container holder may be configured to threadably engage the container aperture, and thereby form a secure hold thereto.

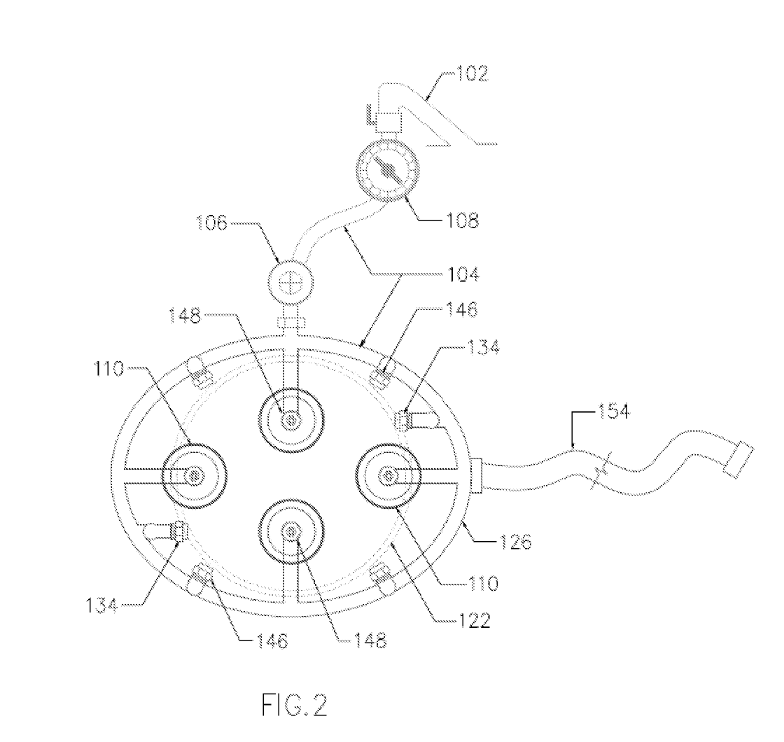

FIG. 2 illustrates a top view of an exemplary container washing system, in accordance with an embodiment of the present invention. In the present invention, the washing system may provide multiple layers of jet nozzles in an enclosed system for washing a container accessory, a container inner surface, and a container outer surface. The container may be held in place through various fasteners while being washed under heavy pressure. The container may be defined by the inner surface, which engages the contents of the container, and the outer surface, which forms a surface for manipulating the container. The jet nozzles may be configured to orient and position around the container and the container accessory to optimize the washing process in the outer surface, and the often difficult to access inner surface.

In some embodiments, the inlet conduit may include plastic conduits that connect a series of jet nozzles. The nozzles may be installed and directed inwards, around and/or by way of water rotational force. In this manner, the at least two accessory nozzles are configured to spin on the accessory nozzle arm above the containers. A container accessory frame, such as a rack or holder may hold all container accessories, such as baby bottle attachments.

In some embodiments, the system may be attached to a sink faucet through a diverter valve. The timer portion, such as a timing mechanism, may be mounted proximally to the fluid source to shut-off the fluid flow into the system after a pre-set running cycle is complete. A cleaning composition dispenser, such as a soap dispenser is also installed to enhance the cleaning process. The inner nozzles may be designed to wash the inside of the containers and are fitted in such a way that they spray upwards through an oversized opening in the center of the lower container holder where container to be washed are screwed down in place to prevent being dislodged during the washing process. The container aperture in the center of the container also act as drainage for dirty water flowing out of the container.

Before using the system, the container may be placed on the kitchen sink or a drain hose is provided to facilitate drainage of prior fluids into the sink. For example, dirty baby bottles are screwed upside down onto the lower container holder while small items are placed in the container accessory frame inside the system. Then the cover, which may be transparent, is placed over the upper end to prevent the fluid from spraying around the sink area. After setting the timer portion, the fluid source is turned on to force fluid through the inlet conduit and into the appropriate nozzles. After a few seconds of running the fluid, a cleaning composition, such as liquid detergent may be injected into the system to start the cleaning process. The high pressure hot water jets coming out of the nozzles guarantee a very effective washing method against even the most stubborn and crusted debris inside the bottles. When the cycle in the timer portion terminates, the bottles and attachments are thoroughly cleaned. The system may be removed from the sink and conveniently stored within easy reach of the sink area for future use.

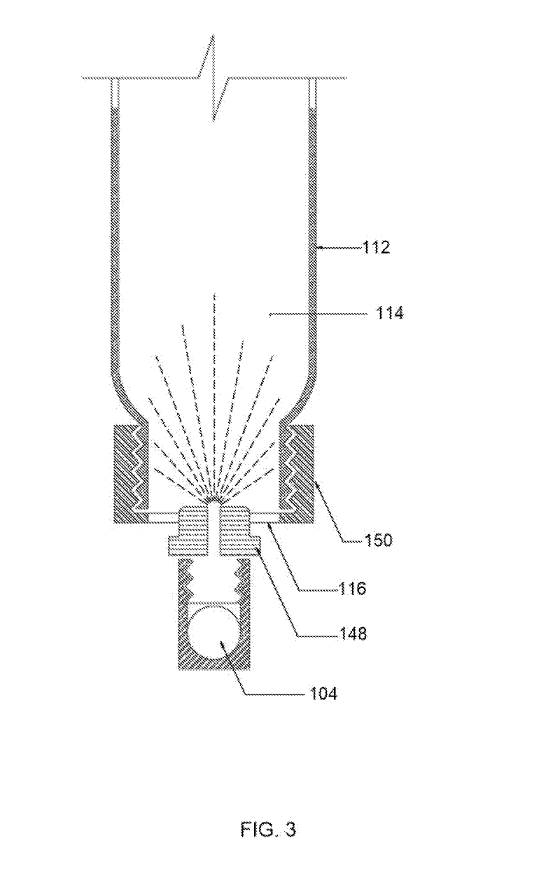

FIG. 3 illustrates a sectioned side view of an exemplary inner nozzle washing an exemplary container inner surface, in accordance with an embodiment of the present invention. In the present invention, the inlet conduit may carry a portion of the fluid, which was not used in the at least two accessory nozzles and the at least one outer nozzle, to at least one inner nozzle. The inner nozzle may be configured to discharge a portion of the fluid through the container aperture for at least partial engagement with a container inner surface. The inner nozzle is disposed to at least partially enter the container from a generally linear configuration. In some embodiments, the accessory nozzles, the outer nozzle, and the inner nozzle may include a jet nozzle configuration that imparts high pressure fluid. The container holder helps maintain the positioning of the container while washing under this high pressure.

In one alternative embodiment, the fluid may include an abrasive acid that breaks down debris more effectively than hot soapy water. In another alternative embodiment, the at least two accessory nozzles may include eight or more nozzles oriented from three dimensions around the container accessory. In another alternative embodiment, the system may be injected full of the fluid for presoaking the containers prior to washing with the nozzles. In another alternative embodiment, the inner nozzle includes a movable tip that can be externally controlled to point in multiple directions inside the container.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a multi-level container washing system with no moving parts or electrical power according to the present invention will be apparent to those skilled in the art. Various aspects of the invention have been described above by way of illustration, and the specific embodiments disclosed are not intended to limit the invention to the particular forms disclosed. The particular implementation of the multi-level container washing system with no moving parts or electrical power may vary depending upon the particular context or application. By way of example, and not limitation, the multi-level container washing system with no moving parts or electrical power described in the foregoing were principally directed to a system to clean baby bottles with a kitchen sink faucet water source and multiple levels of jet nozzles to clean an inner surface, an outer surface, and bottle accessories implementations; however, similar techniques may instead be applied to commercial recycling plants that reuse soda bottles, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A system comprising:
a fluid source configured to at least partially provide a fluid, said fluid configured to at least partially wash a container accessory and a container;
a container accessory frame configured to support said container accessory;
at least two accessory nozzles disposed proximally to said container accessory, said at least two accessory nozzles configured to discharge a portion of said fluid in at least two opposing fluid currents, said at least two opposing fluid currents configured to at least partially engage said container accessory;
a container frame configured to support said container;
at least one outer nozzle disposed proximally to said container, said at least one outer nozzle configured to discharge a portion of said fluid on a container outer surface;
at least one inner nozzle disposed to at least partially enter said container, said at least one inner nozzle configured to discharge a portion of said fluid on a container inner surface;
an upper container holder configured to retain a container bottom end in a predetermined position for washing; and
a lower container holder configured to retain a container aperture in said predetermined position for washing.

2. The system of claim 1, in which said container comprises a baby bottle.

3. The system of claim 2, in which said fluid source comprises a water faucet.

4. The system of claim 3, in which said fluid comprises hot water, said fluid further comprising a high pressure fluid.

5. The system of claim 4, in which said system comprises an inlet conduit configured to carry said fluid from said fluid source to said at least two accessory nozzles and/or said at least one outer nozzle and/or said at least one inner nozzle, said inlet conduit comprising adjustable piping.

6. The system of claim 5, in which said at least two accessory nozzles and/or said at least one outer nozzle and/or said at least one inner nozzle comprises a jet nozzle, said jet nozzle configured to impart a high pressure fluid.

7. The system of claim 6, in which said inlet conduit comprises a timer portion configured to regulate flow of said fluid, said timer portion further configured to shut-off a flow of said fluid through said inlet conduit after a predetermined running cycle terminates.

8. The system of claim 7, in which said inlet conduit comprises a cleaning composition dispenser configured to at least partially dispense a cleaning composition into said fluid.

9. The system of claim 8, in which said container accessory frame is disposed to position on an upper end of said system.

10. The system of claim 9, in which said system comprises a cover configured to at least partially inhibit said fluid from spilling out of said upper end.

11. The system of claim 10, in which said a container accessory frame comprises at least one accessory frame aperture configured to enable a portion of said at least two opposing fluid currents to pass.

12. The system of claim 11, in which said container frame is disposed to position on a lower end of said system.

13. The system of claim 12, in which said upper container holder is disposed to adjustably extend and retract along a longitudinal axis of said container, said upper container holder comprising a rod configured to extend and retract, said rod comprising a first end disposed to join with said container frame, said rod further comprising a second end, said second end comprising a retaining plane configured to engage said container bottom end.

14. The system of claim 13, in which said container frame comprises a lower container holder configured to threadably engage a container aperture.

15. The system of claim 14, in which said at least two accessory nozzles join with a rotatable arm, said rotatable arm disposed to join with said inlet conduit, said rotatable arm further disposed to position above said container accessory, said rotatable arm configured to actuate in response to said high pressure.

16. The system of claim 15, in which said at least one outer nozzle is configured to spray at an angle of up to 120 degrees.

17. The system of claim 16, in which said at least one inner nozzle is configured to at least partially enter said container through said container aperture, said at least one inner nozzle further configured to form a linear configuration.

18. The system of claim 17, in which said container frame is disposed to position above a drain pan, said drain pan configured to guide said drainage fluid through a drain conduit, said drain conduit comprising a kitchen sink.

19. A system comprising:
means for joining an inlet conduit to a fluid source;
means for discharging a fluid from the fluid source for cleaning a container accessory and a container;
means for setting a timer portion;
means for dispensing a cleaning composition from a cleaning composition dispenser;
means for discharging a portion of said fluid from at least two accessory nozzles onto said container accessory;
means for discharging a portion of said fluid from at least one outer nozzle onto a container outer surface;
means for discharging a portion of said fluid from at least one inner nozzle onto a container inner surface; and
means for draining a drainage fluid from said system.

20. A system consisting of:
a fluid source configured to at least partially provide a fluid, said fluid source comprising a sink faucet, said fluid comprising hot water, said fluid configured to at least partially wash a container accessory and a container, said container accessory comprising a baby bottle nipple, said container comprising a baby bottle;
a container accessory frame configured to at least partially support said container accessory, said container accessory frame disposed to position on an upper end of said system, said container accessory frame comprising at least one accessory frame aperture configured to enable at least partial passage of a drainage fluid;
a cover configured to at least partially inhibit said fluid from spilling out of said upper end;
at least two accessory nozzles disposed proximally to said container accessory, said at least two accessory nozzles configured to discharge a portion of said fluid in at least two opposing fluid currents, said at least two opposing fluid currents configured to form a whirlpool, said at least two opposing fluid currents configured to at least partially engage said container accessory;
a container frame configured to at least partially support said container;
at least one outer nozzle disposed proximally to said container, said at least one outer nozzle configured to discharge a portion of said fluid on a container outer surface, said at least one outer nozzle configured to spray at an angle of up to 120 degrees; and
at least one inner nozzle disposed to at least partially enter said container through a container aperture, said at least one inner nozzle configured to form a linear configuration, said at least one inner nozzle configured to discharge a portion of said fluid on a container inner surface.
